(19) United States
(12) Patent Application Publication
(10) Pub. No.: US 2012/0183033 A1
(43) Pub. Date: Jul. 19, 2012

(54) RECEIVING AN INPUT SIGNAL OVER A CHANNEL OF A WIRELESS NETWORK

(76) Inventors: Stephen Allpress, Bristol (GB); Edward Andrews, Bristol (GB); Simon Huckett, Bristol (GB); Laolu Lijofi, Bristol (GB); Jonathan Peter Lucas, Bristol (GB); Carlo Luschi, Oxford (GB); Simon Nicholas Walker, Bristol (GB)

(21) Appl. No.: 13/349,132

(22) Filed: Jan. 12, 2012

(30) Foreign Application Priority Data
Jan. 14, 2011 (GB) 1100619.4

(51) Int. Cl. H04B 17/00; H04L 27/01; H04B 7/26

(52) U.S. Cl. 375/224

(57) ABSTRACT

Method, apparatus and computer program product for processing an input signal received over a channel of a wireless network at an apparatus. In one embodiment, an apparatus includes a plurality of receiver processing means, wherein each one of the plurality of receiver processing means is repeatedly selected to perform the processing of the input signal for a respective time interval thereby generating a respective plurality of output signals and, only one of the receiver processing means is selected for said processing at a time. A respective quality measure of each of the plurality of output signals is compared. The selection of the plurality of receiver processing means is controlled in dependence upon the comparison of the quality measures of the output signals, such that the receiver processing means which generates the output signal having the quality measure indicating the highest quality is selected for the longest time interval.

### CROSS-REFERENCE TO RELATED APPLICATION

This application claims the benefit of GB Application No. 1100619.4 filed on Jan. 14, 2011, entitled “Receiving an Input Signal Over a Channel of a Wireless Network,” by Allpress, et al. The above application is commonly assigned with this application and is incorporated herein by reference in its entirety.

### FIELD OF THE INVENTION

The present invention relates to receiving an input signal over a channel of a wireless network.

### BACKGROUND

In order to communicate over a wireless network, signals can be transmitted over channels of the wireless network between nodes, such as between a base station node and User Equipment. As is known in the art, a signal received over a physical channel of a wireless network will generally not be a perfect replica of the signal before it was transmitted over the channel because of effects such as interference and the existence of multiple paths between the transmitter and the receiver, etc. Therefore some processing (such as digital signal processing) may be performed on a received signal in an attempt to remove or diminish some of the effects of the channel on the signal. Many different receiver processing methods (often simply termed “receivers” in the art) are available for digital signal processing which can remove (or at least diminish) the effects of a channel through which a received signal has passed. For example, according to 3^{rd} Generation Partnership Project (3GPP) standards, signals may be received using an equalizer and/or a rake receiver. The 3GPP defines different types of receivers (i.e. receiver processing methods) as shown in Table 1 below. Interference aware receivers, referred to as type 2i and type 3i were defined as extensions of the existing type 2 and type 3 receivers respectively. As is known in the art, interference aware receivers take into account not only the channel response matrix of a serving cell, but also the channel response matrices of the most significant interfering cells.

TABLE 1
3GPP receiver types

| 3GPP Name | Receiver |
|---|---|
| Type 0 | RAKE |
| Type 1 | Diversity receiver (RAKE) |
| Type 2 | Equaliser |
| Type 2i | Equaliser with interference |
| | awareness |
| Type 3 | Diversity equaliser |
| Type 3i | Diversity equaliser with |
| | interference awareness |
| Type M | Multiple Input Multiple Output |
| | (MIMO) |

Different receivers will process the input signal in different ways. Therefore, some receivers may produce higher quality signals than other receivers. “Higher quality” is this context may mean that more of the effects of the channel on the signal are removed. In this sense a higher quality receiver may output signals which more closely match the input signals prior to transmission to the apparatus over the channel.

Since different receiver methods perform differently it can be useful to select the optimum receiver method for processing the received signal (i.e. to select the receiver method which outputs the highest quality signal). However, it may be the case that in some operating conditions one particular receiver processing method provides the highest quality signal, whereas in other operating conditions a different one of the receiver processing methods may provide the highest quality signal. It can therefore be useful to adaptively select between different receiver processing methods as operating conditions change. In other words, for optimum performance, the choice of which receiver to use depends on the channel conditions, which typically are constantly changing.

FIG. 1 shows blocks of an apparatus 100 for processing a received signal. The apparatus comprises an input line 102, a multiplexer 104, a first receiver processing block 106 for implementing a first receiver processing method R1, a second receiver processing block 108 for implementing a second receiver processing method R2, an output line 110 and an analyser block 112. The input line 102 is coupled to a data input of the multiplexer 104 and to an input of the analyser block 112. An output of the analyser block 112 is coupled to a control input of the multiplexer 104. A first data output of the multiplexer 104 is coupled to the first receiver processing block 106. An output of the first receiver processing block 106 is coupled to the output line 110. A second data output of the multiplexer 104 is coupled to the second receiver processing block 108. An output of the second receiver processing block 108 is coupled to the output line 110.

In operation, the apparatus 100 receives an input signal A on line 102. The input signal A may comprise an input symbol stream. The input signal A is passed to the multiplexer 104. The multiplexer 104 selects to pass the input signal to either the first receiver processing block 106 or the second receiver processing block 108 depending upon the control signal received at the multiplexer 104 from the analyser block 112. The signal is then processed by either the first receiver processing block 106 or the second receiver processing block 108 before being passed to the output line 110. The analyser block 112 receives the input signal A and analyses the input signal in order to determine which of the receiver processing method R1 and the receiver processing method R2 would be better to use for processing the input signal, and then sends an appropriate signal to the control input of the multiplexer 104 such that the better of the two receiver processing blocks (106 or 108) is used to process the input signal.

In this sense, the analyser block 112 drives the multiplexer 104 to enable, or otherwise, the receiver processing blocks 106 and 108 accordingly. A person skilled in the art would be aware that the analyser block 112 could perform many different types of analysis of the input signal in order to determine whether the first or second receiver processing method (R1 or R2) should be used to process the input signal. For example, the analyser block could analyse the input signal to determine one of: (i) the dispersion of the input signal, (ii) the number of significant paths of the channel, (iii) the Doppler effect experienced by the signal as it is transmitted over the channel, (iv) the signal to noise ratio (SNR) of the input signal, or (v) interfering signals from other cells of the wireless network.

Prior to selecting either R1 or R2, the analyser block 112 attempts to detect the conditions in which a particular algorithm (either R1 or R2) operates best, and then selects the algorithm based on this detection. The apparatus 100 is theoretically sound, but has significant implementational difficulties. Firstly, it relies on the detection process (performed by the analyser block 112) to be highly reliable, which in practice is not always the case. Secondly, the tuning of the receiver selection depends on many input variables (e.g. the number of detected interferers, the relative power of the interferers, a geometry estimate, etc) and so selecting the right output for all of these inputs may prove impractical. In other words it is difficult in practice for the analyser block 112 to sufficiently analyse the input signal to reliably control the multiplexer 104 to select the optimum receiver processing block from the first receiver processing block 106 and the second receiver processing block 108. This is particularly true in situations in which the channel conditions are changing rapidly, for example if the apparatus is a mobile user terminal and the mobile user terminal is moving.

It can therefore be seen that the prior art apparatus 100 described above may not be capable of reliably selecting the optimum receiver processing method for processing an input signal received over a channel of a wireless network.

### SUMMARY

The inventors have realised that the apparatus 100 shown in FIG. 1 does not reliably select the most optimum receiver processing method for processing a received input signal. In embodiments of the present invention, instead of analysing the input signal (e.g. using an analyser block such as block 116 in FIG. 1) in order to select a receiver processing method, each of the receiver processing methods is used in turn to process the received signal and the quality of the processed output signals are compared in order to determine which of the receiver processing methods provides the highest quality signal, and then that receiver processing method is selected. In this way the actual results of using the available receiver processing methods are used in order to select the optimum receiver processing method. This provides a much more reliable selection than that of the apparatus 100 shown in FIG. 1 which attempts to predict which receiver processing method will provide the best results without using actual output signals from both of the receiver processing methods (R1 and R2).

In other words, in embodiments of the invention, instead of using a type of forward error prediction, a type of feedback mechanism is used for selecting a receiver processing method. This can be advantageous because the selection of the receiver processing method is based on the instantaneous performance of each of the receiver processing methods regardless of the input conditions. A more reliable selection of the best receiver processing method is achieved. The “best” receiver processing method is the one which provides an output signal which has the highest quality (e.g. which most closely matches the input signal prior to transmission over the channel).

According to a first aspect of the invention there is provided a method of processing an input signal received over a channel of a wireless network at an apparatus comprising a plurality of receiver processing means, each receiver processing means being for processing the input signal to generate an output signal in which an effect of the channel on the received input signal is diminished, the method comprising: repeatedly selecting each one of the plurality of receiver processing means to perform said processing of the input signal for a respective time interval thereby generating a respective plurality of output signals, wherein only one of said receiver processing means is selected for said processing at a time; comparing a respective quality measure of each of the plurality of output signals; and controlling said selection of the plurality of receiver processing means in dependence upon said comparison of the quality measures of the output signals, such that the receiver processing means which generates the output signal having the quality measure indicating the highest quality is selected for the longest time interval.

According to a second aspect of the invention there is provided an apparatus for processing an input signal received over a channel of a wireless network, the apparatus comprising: a plurality of receiver processing means, each receiver processing means being for processing the input signal to generate an output signal in which an effect of the channel on the received input signal is diminished; selection means for repeatedly selecting each one of the plurality of receiver processing means to perform said processing of the input signal for a respective time interval thereby generating a respective plurality of output signals, wherein only one of said receiver processing means is selected for said processing at a time; comparison means for comparing a respective quality measure of each of the plurality of output signals; and control means for controlling the selection of the plurality of receiver processing means by the selection means in dependence upon the comparison of the quality measures of the output signals performed by the comparison means, such that the selection means selects, for the longest time interval, the receiver processing means which generates the output signal having the quality measure indicating the highest quality.

According to a third aspect of the invention there is provided a computer program product comprising computer readable instructions for execution by computer processing means at an apparatus for processing an input signal received over a channel of a wireless network, the apparatus comprising a plurality of receiver processing means, each receiver processing means being for processing the input signal to generate an output signal in which an effect of the channel on the received input signal is diminished, the instructions comprising instructions for: repeatedly selecting each one of the plurality of receiver processing means to perform said processing of the input signal for a respective time interval thereby generating a respective plurality of output signals, wherein only one of said receiver processing means is selected for said processing at a time; comparing a respective quality measure of each of the plurality of output signals; and controlling said selection of the plurality of receiver processing means in dependence upon said comparison of the quality measures of the output signals, such that the receiver processing means which generates the output signal having the quality measure indicating the highest quality is selected for the longest time interval.

Only one of the receiver processing means is selected at a time. Therefore no power or processing resources are wasted by unnecessarily processing the input signal using more than one receiver processing means at a time. This is particularly advantageous when the receiver processing means are implemented in software because simultaneously using more than one receiver processing means implemented in software would require a very large amount of processing resources, which may not be available in some apparatuses in which the embodiments of the invention may be implemented, such as in mobile user terminals. In preferred embodiments, each of the receiver processing means is implemented in a respective software module on the apparatus.

Instead of relying on the measurement of specific parameters for determining which receiver to use (e.g. type 3i Equaliser, type 3 equaliser or rake receiver), the apparatus 300 periodically checks whether any of the other available receivers would give better performance and if so it switches over to that other receiver. This periodic checking may be known as “sniffing”.

In some embodiments, the step of comparing a respective quality measure of each of the plurality of output signals comprises: during the respective time interval for which each of the receiver processing means is selected, storing the output signal outputted from that receiver processing means; determining the quality measure of the stored output signals for each of the plurality of output signals; and comparing the determined quality measures for each of the plurality of output signals. In other embodiments, the step of comparing a respective quality measure of each of the plurality of output signals comprises: during the respective time interval for which each of the receiver processing means is selected, determining and storing the quality measure of the output signal outputted from that receiver processing means; and comparing the stored quality measures for each of the plurality of output signals.

In preferred embodiments, the receiver processing means which provides an output signal having a quality measure indicating the highest quality is favoured. The term “favoured” here is used to mean that that particular receiver processing means is selected for the longest time interval for use in processing the input signal. In this way, the input signal may be processed by the optimum receiver processing means for a longer time interval than it is processed by less optimal receiver processing means. In preferred embodiments, the processing of the input signal is predominantly performed by the receiver processing means which provides an output signal having the highest quality (i.e. the output signal whose quality measure indicates the highest quality).

At least one of the receiver processing means may be an equaliser. For example, one of the receiver processing means may be a type 3 equaliser and another of the receiver processing means may be a type 3i equaliser. In some embodiments, all of the receiver processing means are equalisers. In other embodiments, one of the receiver processing means is a rake receiver.

In some embodiments, there are only two receiver processing means implemented in the apparatus, i.e. a first receiver processing means and a second receiver processing means. In these embodiments, the two receiver processing means may be alternately selected for respective first and second time intervals.

In some embodiments, the ratio between the first and second time intervals is either a fixed value (e.g. 99) or the reciprocal of the fixed value (e.g. 1/99). In other embodiments, the ratio between the first and second time intervals is variable beyond being either a fixed value or the reciprocal of the fixed value (e.g. the ratio can take values other than 99 and 1/99). Where the ratio between the first and second time intervals is variable beyond being either a fixed value or the reciprocal of the fixed value, the ratio may be varied based on the quality measures of the output signals.

In preferred embodiments, the quality metric is extracted from a Common Pilot Channel (CPICH). The quality metric could be extracted from another channel, such as a data channel. However, it may be advantageous for the input signal to be received on the CPICH since such signals are continuous, whereas the data channels may not be. This is one reason why the preferred embodiments use the signals transmitted on the CPICH. This allows the signals on the CPICH to be used as a known reference signal. By using a known reference signal, variations in the signal will have less impact on the accuracy of the comparison of the quality of the output signals from the different receiver processing methods. However, an alternative embodiment may use the control bits transmitted and received on the Dedicated Physical Channel (DPCH) or the Fractional DPCH (FDPCH) channels as the input to the quality metric generators as these are also continuously transmitted, e.g. the TPC or dedicated pilot bits.

It can therefore be seen that in preferred embodiments the optimum receiver method for a 3GPP modem is chosen by periodically selecting all the alternative receiver methods, and then selecting one of them according to some common output metric. In one specific example, the method selects between two types of receiver method by comparing a value of the filtered SNR of a signal recovered from the CPICH for each receiver method.

### BRIEF DESCRIPTION OF THE DRAWINGS

For a better understanding of the present invention and to show how the same may be put into effect, reference will now be made, by way of example, to the following drawings in which:

FIG. 1 shows an apparatus of the prior art for processing an input signal;

FIG. 2 shows a second apparatus for processing an input signal;

FIG. 3 shows an apparatus for processing an input signal according to a preferred embodiment; and

FIG. 4 is a flow chart of a process of processing an input signal according to a preferred embodiment.

### DETAILED DESCRIPTION OF PREFERRED EMBODIMENTS

Preferred embodiments of the invention will now be described by way of example only. Different receiver processing means can be used to remove (or at least diminish), from a received signal, the effects of a channel of a wireless network on which the signal is received. In this sense the receiver processing means remove, or diminish, the channel response from the received signal. The term “receiver” is used the description of the preferred embodiments below to mean a “receiver processing means”, since the term “receiver” is more generally used in the art. Examples of different receivers which may be used are given in Table 1 above, and may for example include a type 3 equaliser, a type 3i equaliser or a rake receiver.

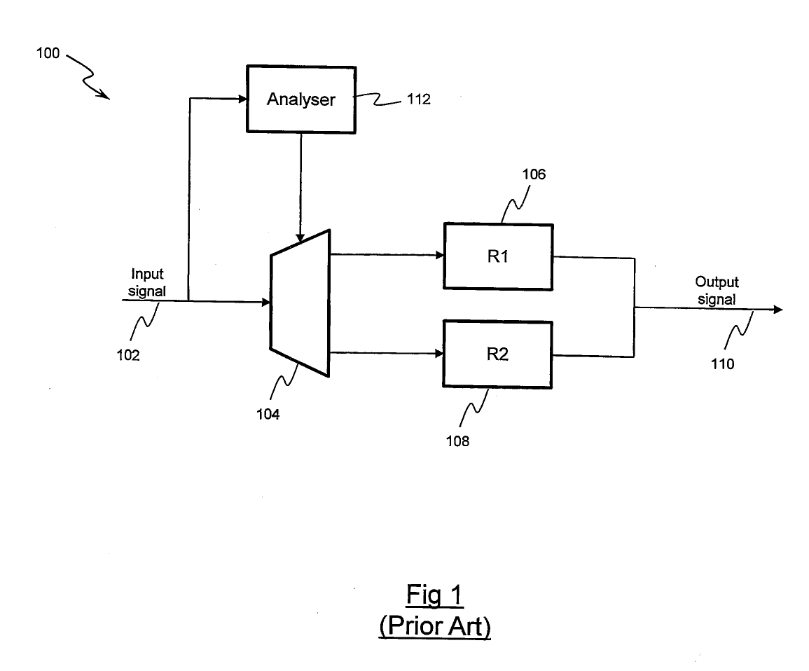

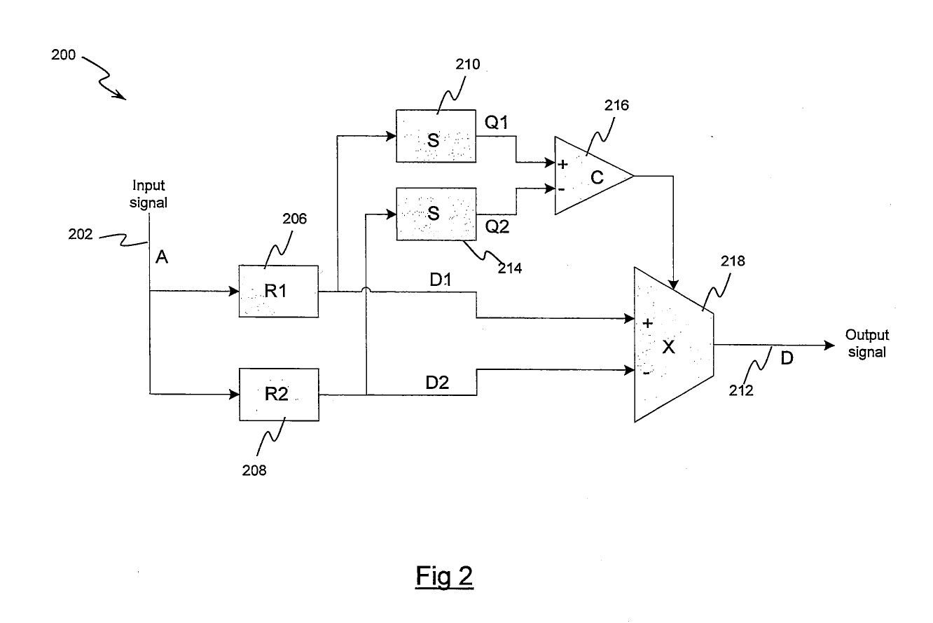

FIG. 2 shows an apparatus 200 which avoids the need to use an analyser block (such as analyser block 112 shown in FIG. 1) in order to select between two different receivers 206 and 208 (R1 and R2) for use in generating an output signal D. The apparatus 200 comprises an input line 202 for receiving an input signal which has been received over a channel of a wireless network. The apparatus 200 also comprises a first receiver R1 206, a second receiver R2 208, a first quality block 210, a second quality block 214, a comparator 216, a multiplexer 218 and an output line 212 for outputting the output signals. The input line 202 is coupled to an input of the first receiver R1 206 and to an input of the second receiver R2 208. An output of the first receiver R1 206 is coupled to an input of the first quality block 210 and to a first data input of the multiplexer 218. An output of the second receiver R2 208 is coupled to an input of the second quality block 214 and to a second data input of the multiplexer 218. An output of the first quality block 210 is coupled to a first input of the comparator 216. An output of the second quality block 214 is coupled to a second input of the comparator 216. An output of the comparator 216 is coupled to the control input of the multiplexer 218. The output of the multiplexer 218 is coupled to the output line 212.

In operation an input signal is received on line 202. The input signal is received at an antenna (not shown) of the apparatus 200 from a channel of a wireless network as is known in the art and passed to the input line 202. The input signal is passed from the input line 202 to the first and second receivers 206 and 208. Both the first and second receivers 206 and 208 process the input signal according to their respective receiver method or algorithm. The first receiver 206 provides a processed signal to the first quality block 210 and the second receiver provides a processed signal to the second quality block 214. The quality blocks 210 and 214 extract a signal quality metric Qₙ from the signal provided from the respective receivers 206 and 208. The quality metric Qₙ provides a measure of the quality of the signal processed by the respective receiver. For example, the quality metric Qₙ may be a signal to noise ratio (SNR) or a block error rate (BER). A skilled person would realise that any quantity which provides an indication of the quality of the signal provided by the receivers (206 and 208) could be determined by the quality blocks 210 and 214 for use as the quality metrics Q₁ and Q₂. The quality metrics Q₁ and Q₂ are passed to the comparator 216. The comparator 216 compares the values of the quality metrics Q₁ and Q₂ to determine which one indicates a higher quality. As shown in FIG. 2 the first quality metric Q₁ is provided to a positive input of the comparator 216 whereas the second quality metric Q₂ is provided to a negative input of the comparator 216. Therefore the sign of the output of the comparator 216 provides an indication as to which quality metric has the highest value. It should be noted that a higher value of the quality metric may, or may not, indicate a higher quality of the signal output from the receivers. For example, a higher SNR indicates a higher quality, whereas a higher BER indicates a lower quality. The output of the comparator controls the multiplexer 218, such that whichever of the signals (D1 or D2) output from the receivers 206 and 208 has a quality metric indicating the highest quality is passed to the output line 212 and is used as the output signal.

In summary of apparatus 200 receivers R1 and R2 take an input symbol stream A and convert it to output streams D1 and D2. The quality blocks marked S extract a signal quality metric Qn from Dn. These quality metrics are compared by a comparator, and the sign of the result of the comparison selects the input of multiplexor 218 to be used to provide the final output stream D. Therefore in apparatus 200, both the receivers 206 and 208 are operated concurrently and the output from the best performing receiver, as judged by some common quality metric (e.g. Signal-to-noise ratio of a known component of the signal; in 3GPP the CPICH is ideal), is selected to be output on line 212.

The elements of apparatus 200 shown in FIG. 2 may be implemented in hardware or software. The apparatus performs well because it selects a receiver (either R1 or R2) based on its instantaneous performance regardless of input conditions. However it has a significant cost: concurrently running all of the receivers wastes power in a hardware-based solution and requires the peak performance of a software solution to be very high, i.e. it requires a large amount of processing power and memory which is not always available, particularly when the apparatus is a mobile device such as a mobile phone.

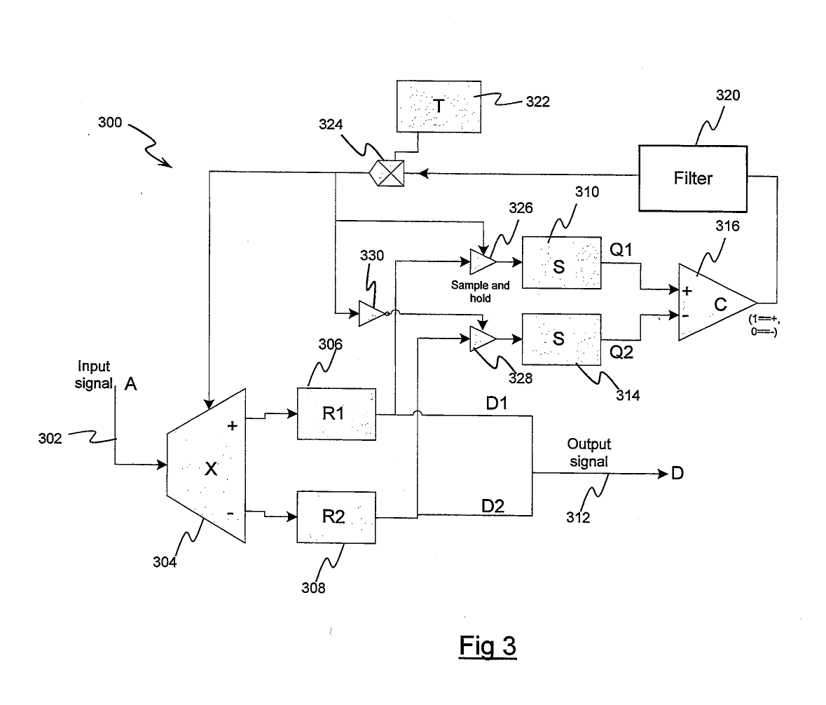

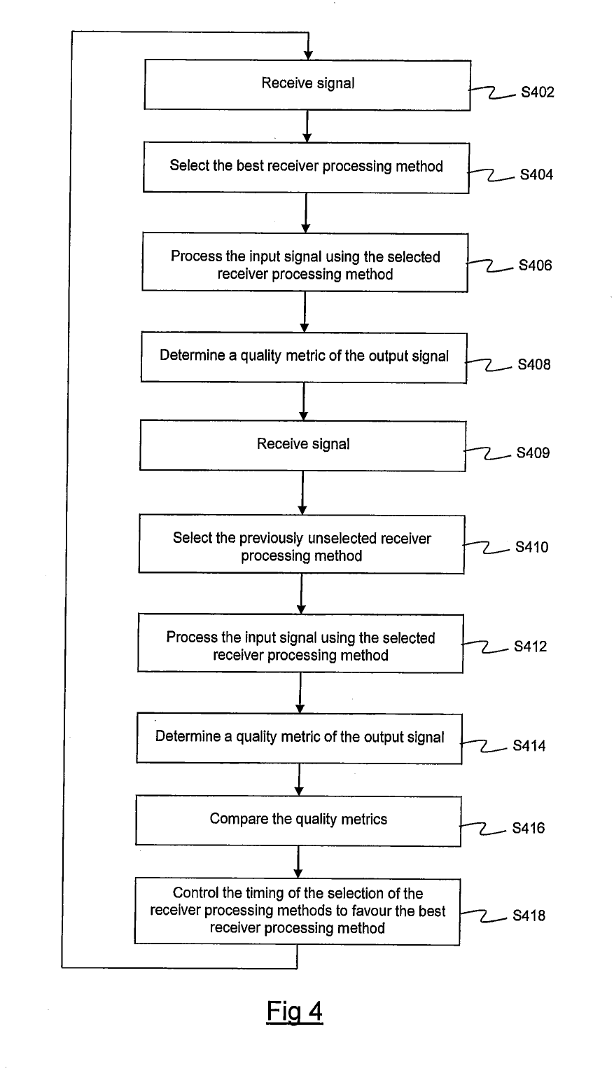

The inventors have realised that the advantages of the two apparatuses 100 and 200 can be combined in one embodiment, as described below with reference to FIGS. 3 and 4. FIG. 3 shows an apparatus 300 for processing an input signal according to a preferred embodiment, whilst FIG. 4 is a flow chart of a process of processing an input signal using the apparatus 300.

The apparatus 300 comprises an input line 302 for receiving an input signal which has been received over a channel of a wireless network. The apparatus 300 also comprises a demultiplexer 304, a first receiver R1 306, a second receiver R2 308, a first quality block 310, a second quality block 314, a comparator 316, a filter block 320, a timer block 322, a selective inverter block 324, a first buffer 326, a second buffer 328, a NOT gate 330 and an output line 312 for outputting the output signals. The input line 302 is coupled to a data input of the demultiplexer 304. A first data output of the demultiplexer 304 is coupled to an input of the first receiver R1 306. A second data output of the demultiplexer 304 is coupled to an input of the second receiver R2 308. An output of the first receiver R1 306 is coupled to an input of the first buffer 326 and to the output line 312. An output of the second receiver R2 308 is coupled to an input of the second buffer 328 and to the output line 312. An output of the first buffer 326 is coupled to an input of the first quality block 310. An output of the first quality block 310 is coupled to a first input of the comparator 316. An output of the second buffer 328 is coupled to an input of the second quality block 314. An output of the second quality block 314 is coupled to a second input of the comparator 316. An output of the comparator 316 is coupled to an input of the filter block 320. An output of the filter block 320 is coupled to a first input of the selective inverter block 324. An output of the timer block 322 is coupled to a second input of the selective inverter block 324. An output of the selective inverter block 324 is coupled to a control input of the demultiplexer 304. The output of the selective inverter block 324 is also coupled to a control input of the first buffer 326. The output of the selective inverter block 324 is also coupled to a control input of the second buffer 326 via the NOT gate 330.

In operation, in step S402, an input signal is received on line 302. The input signal is received at an antenna (not shown) of the apparatus 300 from a channel of a wireless network as is known in the art and passed to the input line 302. The input signal may comprise an input symbol stream. The input signal is passed from the input line 302 to the demultiplexer 304. In step S404 one the receivers (306 or 308) is selected. As described in more detail below, whichever receiver is providing the highest quality output signal is selected, i.e. the best receiver is selected. In this sense, the input signal is passed to either the first receiver 306 or the second receiver 308, but not to both simultaneously. As described in more detail below, the selection of whether to pass the input signal to the first receiver 306 or the second receiver is determined by the signal passed to the control input of the demultiplexer 304 from the selective inverter block 324. In step S406, whichever receiver is selected processes the input signal and provides an output signal on the output line 312. The signal output from the selected receiver is passed to one of the buffers 326 and 328 where the signal is stored. At a subsequent point in time the signal is passed from the buffer to the respective quality block (310 or 314) and in step S408 the quality block determines a quality metric Qₙ for the output signal.

The signal continues to be received, as signified by step S409 in FIG. 4. At some subsequent point in time, in step S410, the other receiver (the previously unselected receiver) is selected. That other receiver then processes the input signal, in step S412, and provides an output signal to the output line 312 and to the other of the buffers 326 and 328, where the signal is then stored. At a subsequent point in time the signal is passed from the buffer to the respective quality block (310 or 314) and in step S414 the quality block determines a quality metric Qₙ for the output signal. Therefore the buffers 326 and 328 store the most recent signals processed by the respective receivers 306 and 308. The signal stored at the first buffer 326 is passed to the first quality block 310 and the signal stored at the second buffer 328 is passed to the second quality block 314. The quality blocks 310 and 314 extract a signal quality metric Qₙ from the signal provided from the respective buffers 326 and 328. The quality metric Qₙ provides a measure of the quality of the signal processed by the respective receiver. For example, the quality metric Qₙ may be a signal to noise ratio (SNR) or a block error rate (BER). A skilled person would realise that any quantity which provides an indication of the quality of the signal provided by the receivers (306 and 308) could be determined by the quality blocks 310 and 314 for use as the quality metrics Q₁ and Q₂. The quality metrics Q₁ and Q₂ are passed to the comparator 316.

In step S416, the comparator 316 compares the values of the quality metrics Q₁ and Q₂ to determine which quality metric indicates a higher quality. As shown in FIG. 3 the first quality metric Q₁ is provided to a positive input of the comparator 316 whereas the second quality metric Q₂ is provided to a negative input of the comparator 316. Therefore the sign of the output of the comparator 316 provides an indication as to which quality metric has the highest value. It should be noted that a higher value for the quality metric may, or may not, indicate a higher quality of the signal output from the receivers. For example, a higher SNR indicates a higher quality, whereas a higher BER indicates a lower quality.

In step S418 the comparison of the quality metrics is used to control the timing of the selection of the receivers by the demultiplexer 304 in order to favour the receiver which produces the output signals having the highest quality. This is achieved as described below. The receiver selected in step S404 (the best receiver) is selected for a longer time interval than the receiver selected in step S410. In this way the optimum receiver is predominantly used to process the input signal. The signal output from the comparator 316 is passed to the filter block 320. The filter block is used to smooth out rapid changes in the output from the comparator 316. It is possible that the sign of the output of the comparator 316 will change due to noise on the input signal or due to other random, short-lived fluctuations. It may not be desirable to switch the predominant receiver in response to these short-lived fluctuations, and the filter block 320 allows the apparatus 300 to only switch the predominant receiver used to process the input signal when the sign of the output of the comparator 316 switches for a significant duration of time (e.g. longer than the duration of the short-lived fluctuations). The use of the filter block 320 to filter the result of the comparison in the comparator 316 improves the reliability of the selection of the optimum receiver.

The timer block 322 outputs a periodic, square wave signal to the selective inverter block 324. The square wave signal output from the timer block 322 has a mark:space ratio which is not equal to one. For example, the mark:space ratio of the square wave signal may be 99:1. The output of the filter block 320 is passed to the selective inverter 324 and is used to either invert the sense of square wave signal or not. Inverting the sense of the square wave signal would make the mark:space ratio the reciprocal of the original mark:space ratio of the square wave signal. For example, if the square wave output from the timer block 322 has a mark:space ratio of 99:1 and the selective inverter block 324 inverts the sense of the square wave, then the square wave signal output from the selective inverter block 324 would have a mark:space ratio of 1:99.

When the signal provided from the filter block 320 is positive then the selective inverter block 324 does not invert the sense of the square wave received from the timer block 322. However, when the signal provided from the filter block 320 is negative then the selective inverter block 324 does invert the sense of the square wave received from the timer block 322. The selective inverter block 324 could therefore be implemented as an Exclusive NOR gate having the signals from the timer block 322 and the filter block 320 as its two inputs. However, other implementations of the selective inverter block 324 could also be used for producing the same effect, as would be apparent to a person skilled in the art.

The signal output from the selective inverter block 324 is passed to the control input of the demultiplexer 304 and is used to control the demultiplexer 304. In particular, when the signal received at the control input of the demultiplexer 304 is high then the input signal is passed from line 302 to the first receiver 306 (and not to the second receiver 308). However, when the signal received at the control input of the demultiplexer 304 is low then the input signal is passed from line 302 to the second receiver 308 (and not to the first receiver 306).

The signal output from the selective inverter block 324 is also used to control the timing of when the buffers 326 and 328 will sample and hold the signals output from the respective receivers 306 and 308. By passing the signal output from the selective inverter block 324 through the NOT gate 330 to the second buffer 328, the second buffer 328 will sample the signal from the second receiver 308 at the same time as the input signal is passed to the second receiver 308 by the demultiplexer 304. Similarly, by passing the signal output from the selective inverter block 324 directly to the first buffer 326, the first buffer 326 will sample the signal from the first receiver 306 at the same time as the input signal is passed to the first receiver 306 by the demultiplexer 304.

Following step S418, the method passes back to step S402 and repeats steps S402 to S418 continuously in order to continuously ensure that the apparatus is favouring the correct receiver according to the current conditions.

The apparatus 300 combines the best properties of both apparatuses 100 and 200, in that it operates to implement a selection mechanism similar to that of apparatus 200 in which the actual results of using different receivers to process the input signal are compared, but does so whist only turning on one receiver at a time. In other words, instead of running the receivers concurrently it alternates between them. In this way some advantages of apparatus 200 over apparatus 100 are maintained, but some disadvantages are avoided.

Whichever receiver (306 or 308) is currently providing output signals having the highest quality (as determined by the quality metrics Qₙ) is favoured. The term “favoured” here meaning that the receiver (306 or 308) which is currently providing output signals having the highest quality (as determined by the quality metrics Qₙ) is selected for a longer time interval than the other receiver. For example, if the mark:space ratio of the square signal output from the timer block 322 is 99:1 and if the first receiver 306 is currently providing an output signal having a higher quality than the output signal from the second receiver 308 then the first receiver 306 is selected to process the input signal for a time interval which is 99 times longer than the time interval for which the second receiver 308 is selected to process the input signal. This means that whichever receiver (306 or 308) is providing the highest quality signal is predominantly used such that the output signal on line 312 predominantly has the highest quality available from either of the receivers. However, because the other receiver is periodically selected for a short time interval (e.g. in response to the square wave) the apparatus 300 can reliably determine which receiver is currently providing the highest quality output signal. This is particularly useful in operating conditions which change rapidly, for example when the apparatus is a mobile apparatus which is currently moving through a cell of a wireless network such that the channel conditions are rapidly varying.

Having a large difference between the time intervals for which the optimum and the less optimum receivers are used may be beneficial because this means that the detrimental effect of using the less optimum receiver for processing the input signal is not very large. For example, if the square wave having a mark:space ratio of 99:1 as described above is used then the optimum receiver is used 99% of the time and the less optimum receiver is used only 1% of the time for generating the output signal the output line 312. Therefore the detrimental effect of using the less optimum receiver for processing the input signal affects only 1% of the signal. It may therefore be beneficial to use a higher mark:space ratio, e.g. 199:1. However, the higher the mark:space ratio, the longer the apparatus takes to react to changes affecting which receiver is the optimum receiver for the current conditions. This is because the less optimum receiver is only used for a small amount of time (e.g. only once in every 2 seconds). Therefore if the current operating conditions are varying quickly (e.g. such that the receiver which is the optimum receiver changes in a time period of the order of seconds) then the response time of the apparatus may need to be quicker. One way to speed up the response time of the apparatus to changing conditions is to reduce the mark:space ratio (e.g. to 49:1) of the signal output from the timer block 322. However, as described above, reducing the mark:space ratio of the signal output from the timer block 322 will increase the detrimental effect of using the less optimum receiver for processing the input signal. It can therefore be appreciated that it can be useful to carefully choose the mark:space ratio of the signal output from the timer block 322.

The mark:space ratio of the signal output from the timer block 322 may be fixed (e.g. at 99:1). Alternatively the mark:space ratio of the signal output from the timer block 322 may be variable. For example, the mark:space ratio of the signal output from the timer block 322 may be varied in response to the current operating conditions, e.g. the conditions on the channel on which the input signal is received. For example, the mark:space ratio of the signal output from the timer block 322 could be varied based on a measure of the Doppler effect on the input signal received on the channel, which provides an indication of how quickly the conditions on the channel are likely to vary.

The preferred embodiments use the SNR of the signal on the CPICH as the quality metric (Qₙ) since this is a continuous value that is relatively simple to compute in real time and which provides a reliable indication of the quality of the signal. The BER of the signal requires more processing power to compute and often takes longer to compute than the SNR. Furthermore, calculating the BER of the signal may require the use of a decoder (which is not required to calculate the SNR). Therefore, although the BER may be used to compare the quality of the signals output from the different receivers, the preferred embodiments compare the SNR. As described above, the signal on a data channel may also be used as the input signal, but the preferred embodiments use the signal on the CPICH as the input signal.

The output signal may be outputted to a user from the apparatus 300 (e.g. the signal may comprise speech and/or video data). In which case, what is important is that the user perceives the output signal to have a high quality. Therefore, when selecting between the receivers 306 and 308, the receiver which produces an output signal that the user perceives to have the highest quality should be selected. This is not necessarily the output signal which most closely matches the signal that was transmitted over the channel of the wireless network, although this is normally the case. A person skilled in the art would be aware of which characteristics of a signal are important for the perceived quality of the signal. In other scenarios the output signal may not be output to a user, in which case the “perceived” quality may not be important, and instead it may be more important to most closely match the signal that was transmitted over the channel of the wireless network. For example if the signal is a data file that is being transmitted over the wireless network then the “highest quality” output signal will be the signal that most closely matches the data file prior to transmission over the channel.

In summary, in apparatus 300, one (but not both at the same time) of the receivers R1 and R2 are selected via the demultiplexer 304 using a signal from the timer block 322. The timer block 322 outputs a square wave which causes the demultiplexer 304 to select one receiver or the other. The mark-space ratio of the square wave is set such that one of the receivers is selected more often than the other (i.e. the mark:space ratio is not equal to one). The outputs D1 and D2 of each receiver are sampled and held so that the quality metrics Q1 and Q2 may be calculated and compared using the comparator 316. The output of the comparator 316 is then fed back and combined with the timing signal from the timer block 322 such that the sense of the signal from the timer block 322 is inverted if Q2 is greater than Q1 (i.e. if R2 performs better than R1).

In the preferred embodiments described above, the output signals from the respective receivers are stored in buffers 326 and 328 before being passed to the quality blocks 310 and 314. In alternative embodiments, the order of the buffers and the quality blocks may be reversed such that a quality metric for each of the signals output from the receivers is determined and then that quality metric is subsequently stored in a buffer before being passed to the comparator 316. The storing operation is used to ensure that although the receivers 306 and 308 do not simultaneously process the input signal, the output signals from the two receivers can be compared with each other. In this sense, it is not important whether the quality metrics are determined before or after the storing operation.

In the preferred embodiments described above, two receivers are used. In alternative embodiments, there could be more than two different receivers and a quality metric determined from the output signal from each of the receivers could be compared to determine which receiver is providing the highest quality output signal, and then that receiver can be selected by the multiplexer 304 for the longest period of time (i.e. the optimum receiver is favoured). The plurality of receivers in the apparatus may be considered to be a set of receivers, wherein only one of the set of receivers is selected at any one time to process the input signal.

In the preferred embodiments described above, a square wave signal is used to determine the time intervals for which each receiver is selected by the multiplexer 304. The square wave signal of the preferred embodiments is periodic. However, in alternative embodiments, a different signal may be used to determine the time intervals for which each receiver is selected by the multiplexer 304. For example, a random number generator may be used, wherein when the output of the random number generator is below a threshold value then the multiplexer selects one of the receivers and when the output of the random number generator is above a threshold value then the multiplexer selects the other of the receivers. This will result in the time intervals for which the different receivers are selected being non-periodic. The threshold value will then determine the time-averaged ratio of the time intervals for which the different receivers are selected. By varying the threshold value, the time-averaged ratio of the time intervals for which the different receivers are selected can be varied. Using a periodic square wave as described in the preferred embodiments may be advantageous because it is simpler to implement and produces more predictable output signals than using a random number generator. However, in some conditions it may be advantageous to use the random number generator because by making the time intervals for which the different receivers are selected non-periodic, periodic interference characteristics of the input signal may be avoided by the less optimum receiver.

In the preferred embodiments described above the two quality blocks determine the same quality metric (e.g. SNR) from the signal output from the respective receiver. This allows the two quality metrics to be compared with each other. However, it would be possible in other embodiments for the two quality blocks to provide different quality metrics to each other provided that the two quality metrics could still be compared with each other by the comparator 316 to determine which receiver is outputting the highest quality signal.

The elements shown in FIG. 3 may be implemented in software modules or hardware modules. The apparatus 300 shown in FIG. 3 is particularly advantageous over the apparatus 200 shown in FIG. 2 when the receivers 306 and 308 are implemented in software modules because only one of the receivers is used at any one time to process in the input signal, which greatly reduces the processing power and other system requirements for implementing the apparatus.

As would be apparent to a person skilled in the art, the method shown in FIG. 4 may be implemented by executing computer readable instructions stored on a computer program product on a processor of the apparatus 300.

While this invention has been particularly shown and described with reference to preferred embodiments, it will be understood to those skilled in the art that various changes in form and detail may be made without departing from the scope of the invention as defined by the appendant claims.

1. A method of processing an input signal received over a channel of a wireless network at an apparatus comprising a plurality of receiver processing means, each receiver processing means being for processing the input signal to generate an output signal in which an effect of the channel on the received input signal is diminished, the method comprising:
repeatedly selecting each one of the plurality of receiver processing means to perform said processing of the input signal for a respective time interval thereby generating a respective plurality of output signals, wherein only one of said receiver processing means is selected for said processing at a time;
comparing a respective quality measure of each of the plurality of output signals; and
controlling said selection of the plurality of receiver processing means in dependence upon said comparison of the quality measures of the output signals, such that the receiver processing means which generates the output signal having the quality measure indicating the highest quality is selected for the longest time interval.

2. The method of claim 1 wherein said step of comparing a respective quality measure of each of the plurality of output signals comprises:
during the respective time interval for which each of the receiver processing means is selected, storing the output signal outputted from that receiver processing means;
determining the quality measure of the stored output signals for each of the plurality of output signals; and
comparing the determined quality measures for each of the plurality of output signals.

3. The method of claim 1 wherein said step of comparing a respective quality measure of each of the plurality of output signals comprises:
during the respective time interval for which each of the receiver processing means is selected, determining and storing the quality measure of the output signal outputted from that receiver processing means; and
comparing the stored quality measures for each of the plurality of output signals.

4. The method of claim 1 wherein the step of repeatedly selecting each one of the plurality of receiver processing means to perform said processing of the input signal comprises periodically selecting each one of the plurality of receiver processing means to perform said processing of the input signal.

5. The method of claim 1 wherein the plurality of receiver processing means comprises a first receiver processing means and a second receiver processing means,
and wherein the step of repeatedly selecting each one of the plurality of receiver processing means to perform said processing of the input signal for a respective time interval comprises alternately selecting the first and second receiver processing means to perform said processing of the input signal for a respective first and second time interval.

6. The method of claim 5 wherein the ratio between the first and second time intervals is either a fixed value or the reciprocal of the fixed value.

7. The method of claim 6 wherein the fixed value is 99, such that the reciprocal of the fixed value is 1/99.

8. The method of claim 5 wherein the ratio between the first and second time intervals is variable beyond being either a fixed value or the reciprocal of the fixed value.

9. The method of claim 8 further comprising varying the ratio between the first and second time intervals based on said quality measures of the output signals.

10. The method of claim 5 wherein said step of repeatedly selecting each one of the plurality of receiver processing means comprises selecting the first receiver processing means when a square wave signal is high and selecting the second receiver processing means when the square wave signal is low, said square wave signal having a mark:space ratio which is not equal to one, and wherein said step of controlling said selection of the plurality of receiver processing means comprises controlling the mark:space ratio of the square wave signal in dependence upon said comparison of the quality measures of the output signals.

11. The method of claim 5 wherein said step of controlling said selection of the plurality of receiver processing means comprises:
generating a random number; and
comparing the random number with a threshold value,
wherein said selection of the plurality of receiver processing means is controlled in dependence upon said comparison of the random number with the threshold value.

12. The method of claim 1 wherein the input signal is received on a Common Pilot Channel.

13. The method of claim 1 wherein the input signal comprises control bits received on a Dedicated Physical Channel or on Fractional Dedicated Physical Channel.

14. The method of claim 1 wherein each of the receiver processing means is implemented in a respective software module.

15. The method of claim 1 further comprising applying a filter to the result of said comparison of the quality measures of the output signals.

16. An apparatus for processing an input signal received over a channel of a wireless network, the apparatus comprising:
a plurality of receiver processing means, each receiver processing means being for processing the input signal to generate an output signal in which an effect of the channel on the received input signal is diminished;
selection means for repeatedly selecting each one of the plurality of receiver processing means to perform said processing of the input signal for a respective time interval thereby generating a respective plurality of output signals, wherein only one of said receiver processing means is selected for said processing at a time;
comparison means for comparing a respective quality measure of each of the plurality of output signals; and
control means for controlling the selection of the plurality of receiver processing means by the selection means in dependence upon the comparison of the quality measures of the output signals performed by the comparison means, such that the selection means selects, for the longest time interval, the receiver processing means which generates the output signal having the quality measure indicating the highest quality.

17. The apparatus of claim 16 wherein at least one of the receiver processing means is an equaliser.

18. The apparatus of claim 16 wherein one of the receiver processing means is a type 3 equaliser and another of the receiver processing means is a type 3i equaliser.

19. The apparatus of claim 16 wherein all of the receiver processing means are equalisers.

20. The apparatus of claim 16 wherein one of the receiver processing means is a rake receiver.

21. A computer program product comprising computer readable instructions for execution by computer processing means at an apparatus for processing an input signal received over a channel of a wireless network, the apparatus comprising a plurality of receiver processing means, each receiver processing means being for processing the input signal to generate an output signal in which an effect of the channel on the received input signal is diminished, the instructions comprising instructions for:
repeatedly selecting each one of the plurality of receiver processing means to perform said processing of the input signal for a respective time interval thereby generating a respective plurality of output signals, wherein only one of said receiver processing means is selected for said processing at a time;
comparing a respective quality measure of each of the plurality of output signals; and
controlling said selection of the plurality of receiver processing means in dependence upon said comparison of the quality measures of the output signals, such that the receiver processing means which generates the output signal having the quality measure indicating the highest quality is selected for the longest time interval.

22. An apparatus configured to process an input signal received over a channel of a wireless network, the apparatus comprising:
a plurality of receivers, each receiver being configured to process the input signal to generate an output signal in which an effect of the channel on the received input signal is diminished;
a selection block configured to repeatedly select each one of the plurality of receivers to perform said processing of the input signal for a respective time interval thereby generating a respective plurality of output signals, wherein only one of said receivers is selected for said processing at a time;
a comparator configured to compare a respective quality measure of each of the plurality of output signals; and
a control block configured to control the selection of the plurality of receivers by the selection block in dependence upon the comparison of the quality measures of the output signals performed by the comparator, such that the selection block selects, for the longest time interval, the receiver which generates the output signal having the quality measure indicating the highest quality.
